(19) United States
(12) Patent Application Publication
(10) Pub. No.: US 2026/0172276 A1
(43) Pub. Date: Jun. 18, 2026

(54) OBTAINING FEEDBACK IN VIRTUAL MEETINGS

(71) Applicant: Viktor Kaptelinin, Hornefors (SE)

(72) Inventor: Viktor Kaptelinin, Hornefors (SE)

(21) Appl. No.: 19/409,397

(22) Filed: Dec. 4, 2025

Related U.S. Application Data
(63) Continuation-in-part of application No. 18/212,560, filed on Jun. 21, 2023.
(60) Provisional application No. 63/354,200, filed on Jun. 21, 2022.

(51) Int. Cl. H04L 12/18; G06F 3/01

(52) U.S. Cl. CPC H04L 12/1831; G06F 3/017

(57) ABSTRACT

A method and system are provided for obtaining feedback in a teleconference session involving multiple users, each using an electronic device connected via a communication network. A first user performs a feedback-requesting action, such as activating a user interface element, causing a response panel to be displayed on electronic devices of other users. The response panel provides generic response options that are independent of the specific wording of a verbally issued instruction or question communicated through an audio or video channel. Responses entered through the response panel are transmitted to the first user and presented as individual or aggregated feedback. Additional embodiments include automatically disabling poll-related screen objects after predetermined time periods, enabling free-text response panels, allowing poll initiators to edit response panels prior to distribution, using pre-recorded media to trigger feedback requests, and employing gesture-recognition techniques to activate polls without physical contact with the device.

### CROSS-REFERENCE TO RELATED APPLICATIONS

This application is a Continuation-in-Part of U.S. patent application Ser. No. 18/212,560, filed Jun. 21, 2023, with title “OBTAINING FEEDBACK IN VIRTUAL MEETINGS” and naming Viktor Kaptelinin as inventor, which claims the benefit of provisional U.S. Patent Application Ser. No. 63/354,200, filed Jun. 21, 2022 with title “MANAGEMENT OF USER'S INCOMING IMAGES IN VIDEOCONFERENCE SESSIONS” and naming Viktor Kaptelinin as inventor.

### FEDERALLY SPONSORED RESEARCH

Not Applicable.

### BACKGROUND OF THE INVENTION

This invention relates to electronic systems and their interfaces. More specifically, it relates to information technologies that enable communication between several participants connected to each other through a computer network and using teleconferencing technologies, such as videoconferencing technologies, to conduct virtual meetings (such as committee meetings, lectures, seminars, etc.).

In physical meetings, people intuitively use a diversity of perceptual clues and strategies to understand other participants and present themselves to others. In “virtual meetings” supported by teleconferencing technologies (“virtual meetings” are also referred to as “online meetings”, which terms are used interchangeably in the context of this application), the use of such cues and strategies is limited. A person's usage of teleconferencing technologies during a virtual meeting typically involves voice and/or video communication, based on employing microphones, speakers, displays, and one or more video cameras to capture and transmitting a view (or “image”) of the person (i.e., “user view”) to other participants in the meeting.

A potential problem with current teleconferencing systems for virtual meetings is that they do not provide a participant in a meeting with sufficient feedback from other participants.

### SUMMARY OF THE INVENTION

The present invention teaches methods, apparatuses, and software, intended to support a participant in a virtual meeting in obtaining feedback from other participants, and thus help the participant (i.e., a user of a videoconferencing technology) to understand other participants and present themselves to others more efficiently. According to one embodiment of the invention, a participant in a virtual meeting can initiate a poll, in which a question is asked verbally, using a conventional functionality of a teleconferencing/videoconferencing system, and responses are provided by using a response screen object displayed on responders' displays. According to yet another embodiment, a requesting meeting participant (e.g., a presenter) can enable a monitoring feature, so that other participants can select a value of a predefined attribute or attributes, and a combined and preferably anonymous, representation of the selected attribute values is displayed on the display of the requesting participant.

Teleconferencing systems require mechanisms that enable users to obtain timely and structured feedback from other meeting participants without interrupting audio/video communication flows or disrupting screen-shared content. Existing systems typically rely on predefined question-answer structures, require memory-linked question representations, or require natural-language processing of live audio, which introduces latency and increases computational overhead. The present invention provides a technical solution by introducing user-interface components and network-level message-handling procedures that enable a poll initiator to generate and distribute lightweight, generic response panels without linking the response panel to a specific question in memory. This decoupling of channels and actions improves system responsiveness, reduces processor workload, and enhances real-time interaction in teleconferencing environments.

According to an embodiment of the invention, a method is provided for supporting a plurality of users using a plurality of electronic devices to engage in a teleconference session (e.g., “virtual meeting”, “videoconference session” or “online meeting”), said plurality of users comprises a first user and at least a second user, and said plurality of electronic devices comprises at least a first device and a second device, wherein said first user uses said first device and said second user uses said second device, wherein each device in said plurality of devices comprises at least a processor, a display, said display displaying an at least a display window, a microphone, and preferably a video camera configured to be able to capture an image of the first user of said first device, wherein said plurality of devices are connected via a communication network to one another and preferably to a network server or servers, the method comprising the method steps of
a. detecting a user action performed by a user from said plurality of users, said user action being a request for displaying information from said plurality of users (e.g., meeting participants), said requesting user action being performed either before or during said teleconference session; and
presenting information from said plurality of users on an electronic device of said information-requesting user, said electronic device being a device from said plurality of devices.

According to an embodiment of the invention, the requesting user instruction is a question, verbally asked by said first user, using an audio or a video communication channel, to said at least second user (or several users), wherein substantially at the time of asking said question said first participant performs a user action causing displaying a response screen object (thereafter also referred to as “response panel”) on at least said second electronic device (or several devices), wherein said response screen object enables at least said second user (or several users) to choose a response to said question through a user action, such as clicking on a certain clickable button, said response of at least second user (or several users) being displayed to said first user, preferably, anonymously, on said display of said first electronic device.

According to another embodiment, the second user (or several users) is provided with a response panel displayed on said second electronic device, to continuously provide responses during said videoconference session or a part of said session, at time or times of their choosing, to dynamically assess an aspect of said videoconference session (such as a presentation given by said first user), wherein said responses, summarized and preferably anonymized, are continuously displayed on said display of said first user.

### BRIEF DESCRIPTION OF THE DRAWINGS

FIG. 1: illustrates, at a high level of abstraction, the method according to the present invention.

FIGS. 2a-2c: illustrate the first embodiment of the present invention.

FIGS. 3a-3c: Illustrate the second embodiment of the present invention.

FIGS. 4a-4b: Illustrate a ramification of the second embodiment of the present invention.

FIG. 5 illustrates, at a high level of abstraction, the method according to a preferred embodiment of the present invention.

### GLOSSARY

Virtual meetings: In the context of the present invention, virtual meetings are understood as meetings supported by teleconference technologies. Accordingly, virtual meetings are understood as synchronous communication sessions that involve sending messages, including verbal messages, over audio and/or video communication channels provided by teleconference technology. Specifically, virtual meetings involve using user devices' microphones and/or video cameras to capture the messages produced by the user and transmitting the messages in real time to other meeting participants' devices (live streaming).

In addition, meeting participants may communicate by activating user interface (UI) elements on their displays (such as pressing a control to request a conversational floor or typing in a chat message) and/or by streaming pre-recorded media (also referred to as “screen sharing”).

Virtual meetings vs. online meetings vs. videoconference sessions: Virtual meetings typically take place on the internet and take the form of online meetings. Thus, unless specifically mentioned, the terms “virtual meetings” and “online meetings” are used here interchangeably. In general, however, virtual meetings can be supported by any kind of communication network. In addition, virtual meetings often involve the use of video cameras and thus take the form of a videoconference session. Unless specifically mentioned, the terms “virtual meetings” and “videoconference sessions” are used here interchangeably. It is, however, understood that virtual meetings can be implemented as teleconferencing sessions conducted without employing a video communication channel (e.g., some or all the participants may lack video cameras or prefer not to use them). In certain cases, a virtual meeting can only use a video communication channel.

Generic response panel: In the context of the present invention, a “generic response panel” refers to a response panel whose selectable or enterable response options are not tied to the specific content of a particular question and therefore do not require a memory representation linking the panel to a corresponding question. A generic response panel may include predefined selectable options (such as “Yes/No,” “Agree/Disagree,” or numeric scales), and may additionally or alternatively comprise a free-text entry field enabling a respondent to enter arbitrary text suitable for answering a wide range of questions.

### DETAILED DESCRIPTION OF THE INVENTION (PREVIOUSLY PRESENTED material)

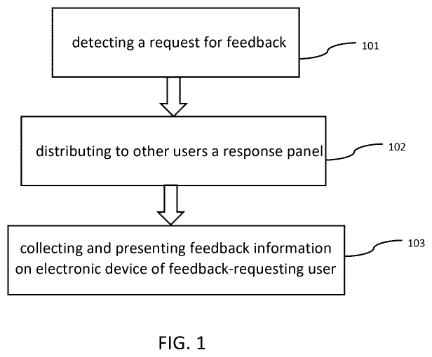

FIGS. 1-4 illustrate embodiments of the present invention. The embodiments are intended to support a participant in an online meeting to help the participant (i.e., a user of a teleconferencing technology) to better understand other meeting participants.

When a person takes part in a virtual meeting, supported by the use of videoconferencing technology, the person is typically presented with “participant views”. There are two types of participant views. First, there are participant views of other participants in the meeting. A participant view of this type comprises information about another meeting participant, received by a person and displayed on the receiving person's device. The second type is a person's “self-view”, that is, a person's view (including, e.g., a video image captured by a person's own camera), which is displayed to the person themselves. A self-view may be used by a person to see how they are viewed by other meeting participants. A participant view may not only be a view of one particular person, but it can also be a view of several people, e.g., several people using the same device or being in the same videoconference-enabled room.

In addition to sending and receiving their views, participants in virtual meetings can also stream other types of images. For instance, a presenter may share an image of a presentation slide or show a video to other participants. In the context of this application, this type of content is referred to as “screen shared”. It is understood that the term “screen-shared” is not limited to content, streamed to other participants using a “screen share” command, but includes various types of media (images and sounds, potentially including other modalities), shared by a meeting participant, and viewed in substantially real time by other meeting participants.

FIG. 1 illustrates a method according to the present invention. A method is provided for supporting a plurality of users using a plurality of electronic devices to engage in a teleconference session, said plurality of users comprises a first user and at least a second user, and said plurality of electronic devices comprises a first device used by said first user and at least a second device used by said at least second user, wherein each device in said plurality of devices comprises at least a processor, a display, said display displaying an at least a display window, a microphone, wherein said plurality of devices are connected via a communication network to one another and preferably to a network server or servers, the method comprising the method steps of
detecting a feedback-requesting user action performed by said first user (step 101), said user action being a request for information from said at least first user, said requesting user action being performed either before or during said teleconference session; wherein said requesting user action causes displaying a response screen panel on said electronic device of said at least second user (step 102); wherein said response panel is adapted to be used by said at least second user to provide information requested by said first user; and
transmitting information collected through the use of said response panel from said at least electronic device used by said at least second user to said electronic device used by said first user users; and presenting said transmitted information on said electronic device used by said first user (step 103).

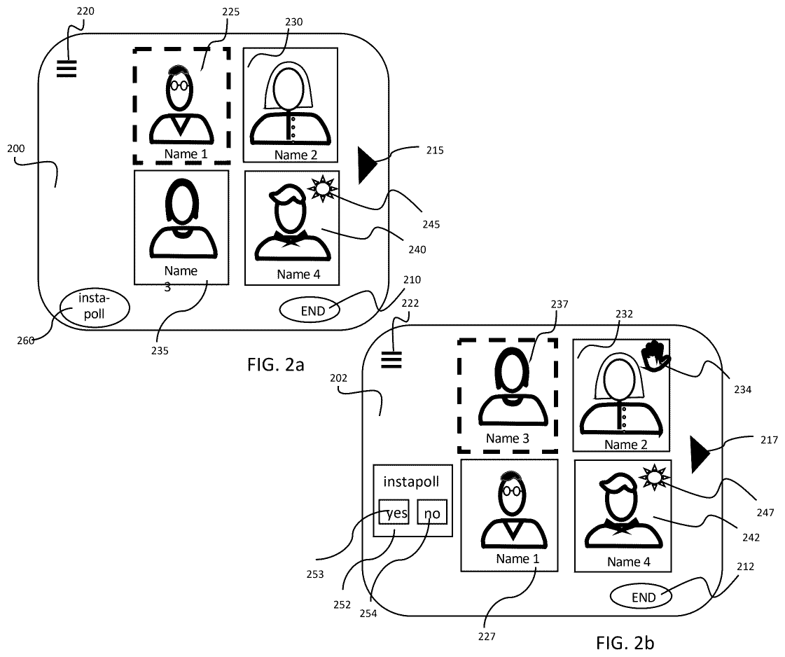

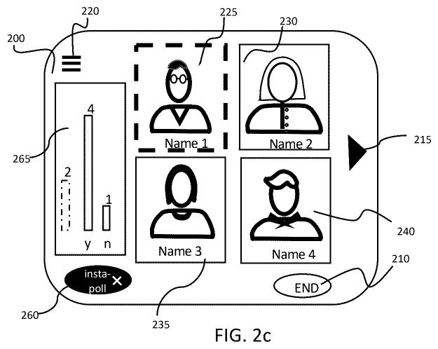

FIG. 2 shows the first embodiment of the invention. The embodiment teaches conducting a lightweight poll during a virtual meeting. According to the embodiment, a participant in a meeting can initiate a poll, in which a question is asked verbally, and responses are provided by other participants in the meeting by choosing an item from a pop-up dialogue box displayed on the participants'displays. The responses are presented to the poll initiator as an integrated anonymous representation. Therefore, the embodiment teaches enabling a user of an electronic device to make electronic devices of other participants in a meeting display a generic response screen object, which object does not include a question (the question is asked by the user verbally) and provides generic response options, suitable for answering a range of questions (such as “yes” and “no”). The responses provided by other users are being collected and displayed (preferably, collated and anonymized) to the poll initiator. The responses may or may not be shared with other users.

Therefore, a method is provided, wherein substantially at the time of performing a feedback-requesting user action causing the display of a response panel on other user's devices, the first user provides a verbal feedback-requesting instruction, using an audio or a video communication channel, to an at least second user; and
wherein said response panel displayed on said electronic device of said at least second user is disabled substantially after said at least second user uses said panel to provide information requested by said first user.

FIG. 2a shows window 200 of a computing device, representing the perspective of user “Name 1”. Window 200 shows button 210, button 220, window elements (panes) 225, 230, 235, and 240 (displaying, respectively, participant views of participants “Name 1”, “Name 2”, “Name 3”, and “Name 4”), as well as button 260 (“Insta-poll”). Button 210 and button 220 are also shown. Activating buttons 210 and 220 results, respectively, in ending the meeting and choosing the level of detail when displaying participants' view in window 200. Window elements (panes) 225, 230, 235, and 240 are shown with a high level of detail (resolution). The level of detail is selected by choosing “Large pics” on menu 220 (not shown). Button 215 is displayed in the right-hand part of window 200, indicating that more participant views can be displayed in window 200 by activating button 215 (which results in scrolling participant views to the right). Button 260 can be activated by participant “Name 1” to elicit responses from other participants in the meeting. Preferably, the button is activated after participant “Name 1” asks a question by talking to (orally addressing) other participants.

FIG. 2 b shows window 202 as it is viewed by meeting participant “Name 3”, after participant “Name 1” had asked their question and clicked button 260 (see FIG. 2a). Window 202 shows button 212, button 222, window elements (panes) 227, 232, 237, and 242 (displaying, respectively, participant views of participants “Name 1”, “Name 2”, “Name 3”, and “Name 4”), as well as pop-up screen panel 252 containing screen buttons 253 (“Yes”) and 254 (“No”). Button 212 and button 222 are also shown. Activating buttons 212 and 222 results, respectively, in ending the meeting and choosing the level of detail when displaying participants view in window 200. Window elements (panes) 227, 232, 237, and 242 are shown with a high level of detail (resolution). The level of detail is selected by choosing “Large pics” on menu 222 (not shown). Button 217 is displayed in the right-hand part of window 202, indicating that more participant views can be displayed in window 202 by activating button 217 (which results in the participant views scrolling to the right). To answer the poll question, asked by participant “Name 1”, participant “Name 3” can activate either button 253 or button 254, after which panel 252 disappears (that is, it is no longer displayed in window 202).

FIG. 2 c shows window 200 of participant “Name 1” after five out of seven other meeting participants answered the question posed by participant “Name 1”. The five other participants provided their responses by using screen panels of the type of panel 252, shown in FIG. 2b. FIG. 2c is similar to FIG. 2a, with the following differences:
a. window 200 displays panel 265, which panel shows a summary of the responses received from other participants; panel 265 indicates that 4 participants answered “yes”, 1 participant answered “no”, and 2 participants haven't answered yet,
b. button 260 is highlighted and contains a small cross image; clicking the button makes panel 265 disappear and changes the appearance of button 260 to button 260 appearance shown in FIG. 2a. If response panels, such as panel 252 displayed to participant “Name 4” (see FIG. 2b), are still displayed to some of the participants, all such panels disappear (are not displayed any longer).

It is understood that numerous variations of the first embodiment are obvious to those skilled in the art and are in the scope of the present invention. Various types of questions can be used, such as real time oral, by showing to a camera a written text. The person initiating the poll may or may not be included in the set of respondents. The polls are preferably anonymous but can also be non-anonymous. Various types of response options on the response panel, provided to the participants, can be used, not only Yes/No, as in FIG. 2, but also Yes/No/Maybe, Yes/No/Abstain, a set of numbered options asking a person to enter an appropriate number, or a scale (e.g., asking a respondent whether they agree with a certain statement and providing a scale from “−3” to “+3”). Poll initiators may be enabled to choose a response panel from a predefined set or construct their own response panel or panels. Various types of response summaries can be presented to the poll initiator, not only bar charts, but also pie charts, tables, etc. Poll results may or may not be presented to meeting participants, who are not poll initiators. Participants'devices may or may not include video cameras.

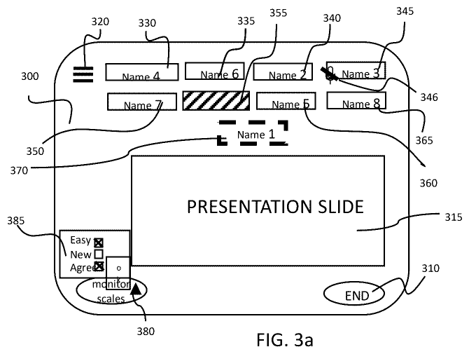

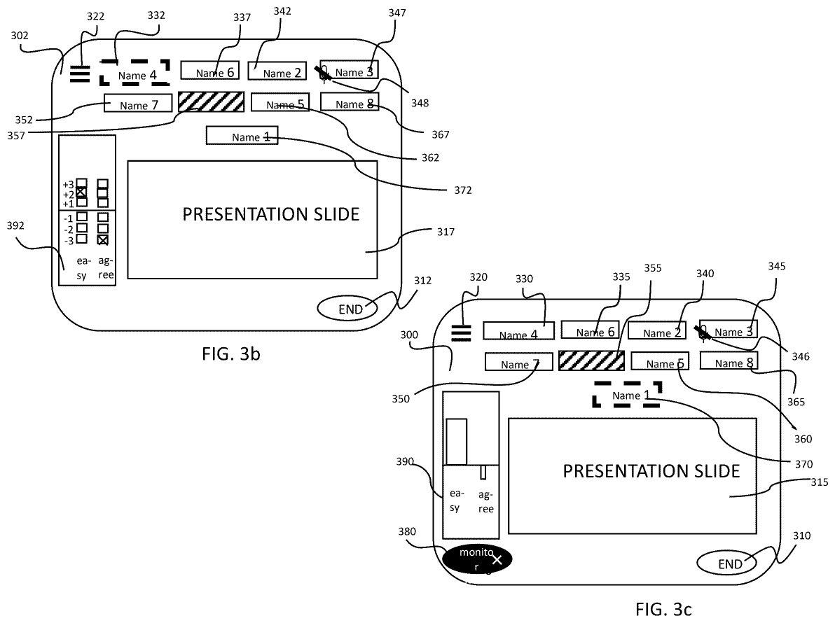

FIG. 3 shows the second embodiment of the invention. The embodiment teaches enabling content-consuming meeting participants (e.g., students) to provide continuous feedback on the content presented by a content-presenting meeting participant (e.g., a lecturer). According to the embodiment, content presented by a content-presenting participant in a meeting can be assessed by other participants in real time according to certain assessment indicators, e.g., using a scale or scales. Essentially, a method is provided, wherein a response panel is substantially continuously displayed on an electronic device of an at least second user during at least a part of a teleconference session, enabling said at least second user, to continuously provide responses during said at least part of said teleconference, at time or times of own choosing, to dynamically assess at least an aspect of said teleconference session;
wherein said assessment responses are collated and continuously displayed on said display of said first user.

FIG. 3a shows window 300 of a computing device, representing the perspective of user “Name 1”. Window 300 shows button 310, button 320, window elements (panes) 330, 335, 340, 345, 350, 360, 365, and 370 (displaying, respectively, participant views of participants “Name 4”, “Name 6”, “Name 2”, “Name 3”, “Name 7”, “Name 5”, and “Name 1”), window element 355 displaying a placeholder, as well as screen button 380 (“Monitor.scales”). Visual cue 346 displayed in substantially window element 345 indicates that participant “Name 3” is muted. Button 310 and button 320 are functionally identical to buttons 110 and 120, shown in FIG. 1: activating buttons 310 and 320 results, respectively, in ending the meeting and choosing the level of detail when displaying participants view in window 300. Window elements (panes) 330, 335, 340, 345, 350, 360, 365, and 370 show participant views with participant names, but not images. The level of detail is selected by choosing “Names” on menu 320. Screen area 315 displays a screen-shared image (“PRESENTATION SLIDE”).

Activating screen button 380 causes pop-up panel 385 to be displayed. The panel allows the user to select a set of scales (using a predefined set of checkboxes) and then request other participants to provide continuous assessment using the selected scales by activating the “ok” button. When the “ok” button is activated, panel 385 stops being displayed, and the button changes appearance as shown in FIG. 3c.

FIG. 3 b shows window 302 as it is viewed by meeting participant “Name 4”, after participant “Name 1” has initiated continuous assessment by clicking “ok” button on panel 385. Window 302 shows button 312, button 322, window elements (panes) 332, 337, 342, 347, 352, 362, 367, and 372 (displaying, respectively, participant views of participants “Name 4”, “Name 6”, “Name 2”, “Name 3”, “Name 7”, “Name 5”, and “Name 1”), window element 357 displaying a placeholder, as well as panel 392 displaying two scales: “easy” and “agree”. Visual cue 348 displayed in substantially window element 347 indicates that participant “Name 3” is muted. Button 312 and button 322 are also shown. Activating buttons 312 and 322 results, respectively, in ending the meeting and choosing the level of detail when displaying participants view in window 302.

Panel 392 is displayed to meeting participants, except for participant “Name 1”, when participant “Name 1” clicks button “ok” on their panel 385. Panel 392 shows two vertical scales, “easy” and “agree”. Each scale is presented by 6 checkboxes, corresponding to values from “−3” to “+3”. To set a score on a scale the user clicks or taps on an appropriate checkbox. FIG. 3b shows two checkboxes selected by participant “Name 4”: “+2” for “easy” (i.e., participant “Name 4” thinks the content is rather easy to understand) and “−3” for “agree” (i.e., participant “Name 4” strongly disagrees). When a checkbox is selected, a score is communicated to participant “Name 1” (e.g., via a server), and the selected checkbox is marked with an “X” for 2 seconds. After that the marking disappears and the scale is reset to “no score”. Participants themselves decide when (and if) they want to express their assessment of the content. It is understood that the assessments are related to the currently presented content, rather than the presentation as a whole. A participant can provide as many (or as few) scores as they wish.

FIG. 3 c shows window 300 of participant “Name 1” after several other meeting participants entered their scores using on-screen panels of the type of panel 392, shown in FIG. 3b. FIG. 3c is similar to FIG. 3a, with the following differences:
window 300 displays panel 390, which panel shows a summary of the scores, which are being currently received from other participants, as a bar chart. The height of a bar indicates the average score, and the width of a bar indicates how many people provided their scores. Panel 390 shown in FIG. 3c indicates that many participants think the current content is easy to understand, and a small number of participants express their disagreement with the content.
button 380 is highlighted and contains a small cross image; clicking the button makes panel 380 disappear, and the appearance of button 380 is changed to what is shown in FIG. 3a. Scale panels displayed to other participants, such as panel 392 displayed to participant “Name 4”, disappear (are not displayed any longer).

It is understood that numerous variations of the second embodiment are obvious to those skilled in the art and are in the scope of the present invention. Various types of assessment attributes and criteria can be used: difficulty to understand, logical inconsistency, how convincing the arguments are, engagement, novelty of the material, etc. The assessments are preferably anonymous but can also be non-anonymous. Individual participants, as they are shown to the feedback-receiving participant (e.g., a speaker or a teacher) may be marked with visual clues if non-anonymous responses are provided: for instance, students' avatars or video panes, as they are viewed by the teacher, can be colored depending on students' answers (e.g., red in case of negative feedback and green in case of positive feedback). Various types of response options on the response panel, provided to the participants, can be used, not only the scales shown in FIG. 3, but also, for instance, simple buttons (e.g., “Unclear” or “Old material”). Assessment initiators may be enabled to choose a response panel from a predefined set or construct their own response panel or panels. Response panels may be always on rather than being activated/deactivated by the assessment initiator. Various types of response summaries can be presented to the assessment initiator, not only bar charts, but also pie charts, tables, etc. Assessment results may only be presented to assessment initiators, but they may also be presented to other meeting participants. An assessment input, provided by a respondent, may be auto reset to a “no input” value (immediately or after a predetermined amount of time) or stay unchanged until the next input provided by the respondent.

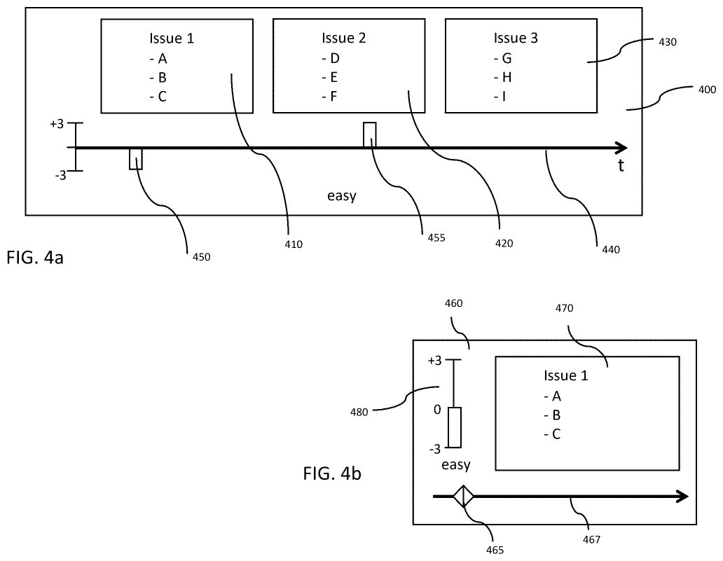

The dynamics of assessment results over the course of a meeting (or a part of a meeting), can be recorded and compared and/or correlated with a wide range of potential other recorded timestamped data concerning the meeting (or the part of the meeting), such as video/audio recording of the meeting, the sequence of presentation slides (e.g., which slides were assessed as “Hard to understand”), chat messages posted, breakout rooms initiated, and so forth. The data can be used to create a combined visual representation, which displays, on the same timeline, both (a) the dynamics of the scores and (b) particular recorded events taking place during the meeting. Such representations can be used, for instance, to reflect upon how the participants assess their experience regarding the material presented to them during the virtual meeting. That ramification of the second embodiment is illustrated by FIG. 4. FIG. 4a shows a combined representation 400, which places slides 410, 420, and 430 on the same timeline 440 as assessment scores 450 and 455. Representation 400 shows that negative feedback was provided when slide 410 was displayed and positive feedback was provided when slide 420 was displayed. A variant of the representation is shown in FIG. 4a. Display window 460 having slider 465, which slider can be moved along timeline 467 to select a certain point of time (or a certain time interval) during the virtual meeting in question. When the point or interval is selected, window 460 displays presentation slide 470, shown at that point during the meeting, as well as assessment 480, which is feedback provided at that time.

Essentially, a method is provided, wherein continuously provided user responses are recorded and employed to produce an image comprising first visual objects representing said continuously provided responses and second visual objects representing at least a type of information, said at least type of information selected from a group comprising at least: video and audio recordings of said virtual meeting, screen-shared images, and participants action, such as chat message postings, floor requests, and reactions/visual feedback, wherein said first visual objects and said second visual objects are presented along a timeline of said teleconference session.

It is understood that FIGS. 1-4, are used by way of illustration, and not limitation. Various additional variations are obvious to those skilled in the art and are therefore within the scope of the present invention: While the current disclosure concerns virtual meetings, it is obvious to those skilled in the art that the scope of the invention covers all kind of communication sessions, including, for instance, non-interactive lectures. Various kinds of devices can be used in accordance with the present invention, including (but not limited to) desktop computers, laptop computers, smartphones, and tablet computers. Such devices may comprise various components, such as displays, microphones, memory storages, processors, input devices, and so forth. They may or may not include video cameras. The components can be either built in or externally connected. Memory storage and data processing according to the present invention may be distributed between user devices and a server or servers, connected via a communication network.

### First Embodiment: Additional Remarks and Clarifications

This section presents additional remarks and clarifications regarding the first embodiment of the invention. The discussion in the section is based on the disclosure in the parent application and does not introduce new subject matter.

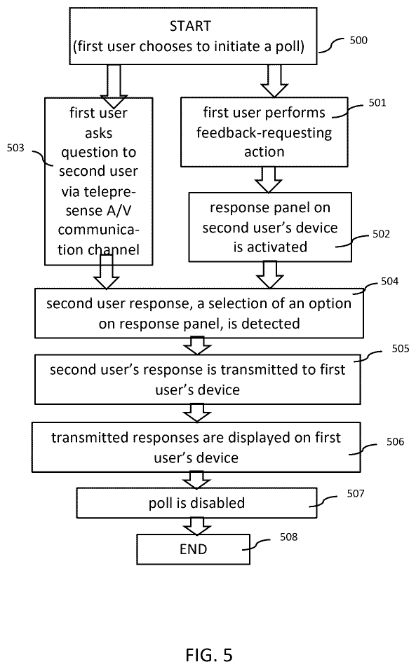

FIG. 5 is a schematic illustration of a method according to the first embodiment. The method describes method steps performed from the moment when a participant (“first user”) chooses to initiate a lightweight poll (step 500). At step 501, the first user performs a feedback-requesting user action; the action activates a response panel on electronic device of at least a second user (step 502). At substantially the time of performing steps 501 and 502, the first user asks a question to the second user via a teleconference technology's audio/video communication channel (step 503). At step 504, second user's response is detected, the response being produced using the response panel activated on a second user's electronic device. At step 505, second user's response is transmitted to the first user's electronic device. The transmitted responses are displayed on the electronic device of the first user (step 506). The poll is disabled by the first user at step 507, and the method concludes in step 508.

The disclosed method cannot be performed by a human alone and is not directed to mental steps or abstract information processing. The invention requires specific technological components—including electronic displays, device processors, microphones, optional video cameras, network communication interfaces, and machine-executed panel-activation routines—to operate. The techniques rely on device-level event detection, real-time UI rendering, and network-based transmission of structured feedback data, forming a concrete technological implementation tied to computer hardware.

The first embodiment of the invention teaches initiating a lightweight single-question poll during a virtual meeting by enabling a user to perform two separate actions: (a) posing a question to other virtual meeting participants and, substantially at the same time, (b) providing response options by activating a response panel with a generic set of selectable options, such as “yes” and “no”, on other users' displays. Since these actions can be performed independently from one another, it is understood that the invention enables the user, if needed and depending on the situation, to perform one of these actions and not the other. If the user wishes to initiate a poll, they perform these two actions at generally the same time. Otherwise, a user may only ask a question (or otherwise request a feedback) without activating a response panel, as the user may seek instead for a different type of response from other participants, e.g., try to stimulate an open discussion or direct a question to a particular participant.

Since, according to the present invention, the “asking a question” and “activating a response panel with response options to the question” are two independent actions separately communicated to responders, and the panel as such has no explicit reference to the question, is it readily understood by a person with ordinary skill in the art that a poll according to the present invention can be conducted without linking the asked question and the corresponding response panel (with its response options) to one another in a computer memory representation related to the teleconference technology supporting the virtual meeting in question.

The invention, therefore, supports conducting lightweight, impromptu polls, as it enables the user to flexibly decide, when asking a question, whether to conduct a poll, or, alternatively, ask a question without conducting a poll. Exercising the flexibility does not require an additional user effort: if the user asks a question and does not want to initiate a poll, they simply do not activate a response panel. The actions of asking a question and initiating a response panel being independent of each other allows employing response panels with no refence to a particular question. Presenting a question and, at the same time, activating a response panel enables a responder to understand that the response panel is provided to answer that question.

Furthermore, it is understood that the term “question” may include feedback-requesting instructions, which do not have the formal linguistic structure of an interrogative sentence but are practically equivalent to questions (e.g., “Please indicate you agreement with the statement that The capital of Myanmar is Naypyidaw.” is practically equivalent to the question “Do you agree with the statement that The capital of Myanmar is Naypyidaw?”).

The first embodiment teaches electronic devices connected to a network server configured to facilitate at least one of: distributing the response panel, transmitting feedback inputs, or aggregating and presenting the feedback input data.

The above description of the first embodiment, illustrated by FIG. 2, discloses a response panel-initiation action, which action is performed by a poll initiator by clicking a button (the “Insta-poll” button 260 shown in FIG. 2a). This disclosure illustrates two aspects of the first embodiment:
first, it illustrates a poll initiator performing a response panel-initiation action by activating a screen object (or “screen control”) on the poll initiator's display, and
second, more specifically, it illustrates a “single-click” response panel-initiation action performed by poll initiator.

### New Subject Matter

In this section, additional variations and embodiments of the present invention, compared to the parent application, are introduced. This new matter complements and extends the parent application disclosure. The section partly comprises a detailed disclosure of certain variations of the first embodiment, which were mentioned in the parent application as obvious variations but were neither developed nor claimed. Upon further analysis, Applicant recognizes that these variations require additional technical description and support. These variations are disclosed in this application as new matter, for which priority is not claimed to the parent application.

### Disabling a Poll-Related Screen Objects After a Period of Time

In addition to the ways of disabling poll-related screen objects, disclosed above, which involve distinct actions performed by either a poll initiator or a respondent, a poll-related screen object can be automatically disabled after a predetermined period of time. In particular, a response panel shown on a responder's display may be disabled if it is not used by the responder to provide feedback, for instance, if no selectable option is selected within a first predetermined amount of time after displaying the response panel. Similarly, a poll results representation on a poll initiator's display, e.g., those of the type shown in FIG. 2c, may be disabled after a second predetermined period of time, even if the poll initiator does not perform an explicit poll-disabling action.

### Free-Text Response Panel

In addition to the types of response panels disclosed above, a generic response panel may be implemented to enable the responders to enter free-text responses. In that case, the response panel on a responder's display may have the form of a text field, in which the responder may enter their text to respond to the poll question. The response panel may preferably include a microcopy explaining the use of the field (e.g., “Type in your response here”). When a poll using such a response panel is completed, the combined representation of the results may be presented as a list of responders' answers. Alternatively, individual answers may be summarized by using an LLM (large language model)-based tool.

### Selecting and Combining Video and Audio Communication Channels

A question asked by a poll initiator may be transmitted to other participants through an audio communication channel only (e.g., the user may not have, or choose to switch off, their camera and only uses their microphone), through a video communication channel only (e.g., using sign language with a switched off microphone), or through a combination of these communication channels. In the latter case a teacher may, for instance, use a camera to show the class a book and use a microphone to say “Do you have this edition of the course textbook?”.

### Reference to a Screen Shared Image

A question may be asked by using an audio-video communication channels of a teleconferencing system (i.e., “live-streamed”) with a reference to a “screen shared” prerecorded media. For instance, a teacher may “screen share” an image of a plant and ask the audience orally “Is it Prinus spinosa?”.

### Editable Response Panels

In an embodiment of the present invention, poll initiators may be able to edit a response panel before distributing the response panel to the participants. For instance, a poll initiating action by the poll initiator may cause first displaying a response panel template, with pre-checked options, such as “yes” and “no”, on the poll initiator's display, so that the poll initiator would be able to edit the response panel, for instance, by additionally checking a “maybe” option.

According to the embodiment, editing a response panel does not create a representation in a system's memory that links a particular question with potential answers to the question. Even if edited, a response panel (a) offers generic response options, suitable for answering a range of questions, and (b) as such, does not contain a reference to a particular question.

### Using Pre-Recorded Media for Feedback Instructions

An additional embodiment of the present invention teaches an implementation that enables the poll initiator to elicit responders' feedback while using a pre-recorded media, such as a video/audio recording or a slide show. According to this embodiment, the poll initiator may activate generic response panels on respondents' displays at an appropriate moment of time during the playback of a pre-recorded media. For instance, if a video of a prerecorded lecture or a film is being played, and a person or character depicted in the video or film is asking a question or making a statement, the poll initiator may initiate a generic response panel being displayed on the devices of other meeting participants. Such a panel can offer selectable options, such as “yes/no” or “disagree/agree”.

Similarly to other embodiments of the present invention, this embodiment teaches initiating a lightweight impromptu poll through two distinct poll initiator's actions:
presenting the responders with a question and providing response options by activating a response panel on responders' displays. The distinct feature of the embodiment is that the poll initiator, when presenting responders with a question, does not generate the question themselves but instead detects a question contained in a pre-recorded media and utilizes the question by generally at the time at which the appropriate part of the pre-recorded media is played (or “streamed”), activating response panels on responders' displays. The results of the poll may be immediately presented to the poll initiator and/or other meeting participants.

In case of a video playback (especially if subtitles are provided), activating response panels may cause pausing the video during the poll.

### Employing Audio-Video Communication Channels to Both Communicate Question and Activate Response Panel

In some embodiments of the present invention, a poll may be conducted by a poll initiator by employing teleconferencing technologies' audio-video communication channels for both communicating a question and activating a response panel. These embodiments constitute an alternative to asking a question using audio-video communication channels and activating a response panel using the user interface of the poll initiator's electronic device, such as engaging with a screen object/control or potentially pressing a button on a remote-control device.

In the embodiments that only use teleconference technologies' A/V communication channels to conduct a poll, two poll initiator's actions according to the present invention—asking a question and activating a response panel—may be performed without the poll initiator physically contacting their electronic device. Instead, both actions are performed by generating audio/video information, which is captured by poll initiator's camera(s) and microphone(s). For instance, a presenter may address the audience by simply talking in front of a camera, while the video and audio information captured at the presenter's site is conveyed real time to the audience. To conduct a poll, the presenter may ask a question verbally and make a gesture, which will activate generic response panels on the audience's displays. In some embodiments, recognizable gestures may include simple movements such as raising an open hand, waving laterally, drawing a symbol in the air (e.g., a question-mark shape), or momentarily covering and uncovering the camera. Gesture recognition may be performed using known computer-vision techniques, including detection of keypoints in successive video frames, optical-flow-based motion analysis, or classification using trained neural-network models.

### Saving and Processing Conducted Polls

As mentioned, conducting a poll according to the present invention does not require creating a memory representation that links the asked question and the corresponding response options. To initiate a poll, a poll initiator does not have to prepare the poll by first creating a description covering both the question and its corresponding response options. Furthermore, the question and the response options are conveyed to the responders separately without a need for cross-references (e.g., providing an explicit reference to a specific question in a response panel). The question and response options can be associated to one another just because of their temporal proximity. Finally, responders' responses can be interpreted by the poll initiator (and potentially other participants) by associating them with the most recent question, again without the need for cross-references and being explicitly linked to each other in a memory representation.

However, while linking a question and response options in computer memory representations is not required, such linking is compatible with the present invention if the linking is performed after a poll initiator has initiated a poll by carrying out two separate actions. For instance, a virtual meeting can be recorded and analyzed, and the analysis may produce an overview of impromptu polls conducted during the meeting. Such an overview, which can be a useful resource for meeting participants, may be supported by a memory representation, explicitly linking the questions and their related response options (as well as actual participants' answers). Since the linking is performed after the poll initiator carried our poll-initiating actions according to the present invention, the representation does not limit the possibilities for conducting lightweight impromptu polls, enabled by the present invention. The presence of optional post-hoc linking does not require, and does not imply, any linking of question and response panel during poll initiation.

Compared to systems that automatically generate polls through natural-language recognition, or systems that require predefined storage and maintenance of question- answer structures, the present invention reduces computational complexity and server-side processing requirements. Because the system does not need to detect, classify, or store user speech, nor create memory associations between questions and responses, the disclosed architecture is more efficient, scalable, and responsive during real-time teleconferencing sessions.

What is claimed is:

1. A method for supporting multiple users, each using an electronic device, to engage in a
teleconference session, the method comprising:
providing a plurality of electronic devices used by a plurality of users, the plurality of users including a first user and at least a second user, and the plurality of electronic devices including a first device used by the first user and at least a second electronic device used by the at least second user;
wherein each of the electronic devices includes a processor, a display configured to present a display window, and a microphone;
wherein the electronic devices are connected to one another via a communication network;
detecting a feedback-requesting user action performed by the first user via activation of a user interface element on the display of the first electronic device, the feedback-requesting user action comprising a request for feedback directed to the at least second user;
in response to the feedback-requesting user action, displaying a response panel on the display of the at least second electronic device of said at least second user, the response panel displaying generic response options suitable for answering a range of questions, the response panel being configured to enable the at least second user to provide the requested feedback to the first user;
providing, during, immediately before, or immediately following said feedback-requesting user action, a verbal instruction by the first user directed at the least second user via an audio or video communication channel, the instruction specifying the type of feedback requested of the at least second user;
transmitting a feedback input from the at least second electronic device to the first electronic device; and
displaying the transmitted feedback input on the display of the first electronic device.

2. The method of claim 1, wherein at least one of said plurality of electronic devices comprises a video camera.

3. The method of claim 1, wherein said instruction is a real time oral question asked by the first user by talking to said at least second user.

4. The method of claim 1, wherein said feedback-requesting user action is a single-click user action.

5. The method of claim 1, wherein a second user's response panel is disabled if no selectable option is selected within a first predetermined amount of time after displaying the response panel.

6. The method of claim 1, wherein the response panel displayed on the electronic device of the at least second user is disabled after the at least second user uses the response panel to provide a feedback response.

7. The method of claim 1, wherein the electronic devices are connected to a network server configured to facilitate at least one of: distributing the response panel, transmitting feedback inputs, or aggregating and presenting the feedback input data.

8. The method of claim 1, wherein the response panel includes selectable options comprising “Yes” and “No”.

9. The method of claim 1, wherein the response panel includes a scale of numeric values indicating a degree of agreement or understanding.

10. The method of claim 1, wherein the feedback input is displayed on the first electronic device as an anonymized summary.

11. The method of claim 1, wherein, a poll results representation displayed on a poll initiator's electronic device is disabled after a second predetermined amount of time.

12. The method of claim 1, wherein a generic response panel is implemented to enable the responders to enter free-text responses.

13. The method of claim 1, wherein a poll initiator is enabled to edit a response panel before distributing the response panel to the participants.

14. A non-transitory computer-readable medium storing instructions that, when executed by a processor of a first electronic device used by a first user, cause the processor to perform a method for supporting a teleconference session involving the first user and a plurality of other users, each using a respective electronic device, the method comprising:
detecting a user action initiated by the first user on the first electronic device, the user action comprising a request for feedback from the plurality of other users;
in response to the user action, transmitting to electronic devices of the plurality of other users a response panel configured to receive feedback input from the other users;
enabling the first user to issue a verbal instruction directed at the plurality of other users via an audio or video communication channel, the verbal instruction corresponding to the request for feedback;
wherein the response panel includes selectable response options corresponding to a predefined set of answers appropriate for various types of questions;
receiving feedback data from the electronic devices of the other users via the response panel; and
collating and displaying the received feedback on the first electronic device.

15. A method for supporting multiple users, each using an electronic device, to engage in a teleconference session, the method comprising:
providing a plurality of electronic devices used by a plurality of users, the plurality of users including a first user and at least a second user, and the plurality of electronic devices including a first device used by the first user and at least a second electronic device used by the at least second user;
wherein each of the electronic devices includes a processor, a display configured to present a display window, a camera, and a microphone;
wherein the electronic devices are connected to one another via a communication network;
detecting, through gesture recognition, a feedback-requesting user action performed by the first user, the feedback-requesting user action being a gesture performed by the first user and captured by a first user's camera, the feedback-requesting user action comprising a request for feedback directed to the at least second user,
in response to the feedback-requesting user action, displaying a response panel on the display of the at least second electronic device of said at least second user, the response panel displaying generic response options suitable for answering a range of questions, the response panel being configured to enable the at least second user to provide the requested feedback to the first user;
providing, during, immediately before, or immediately following said feedback-requesting user action, a verbal instruction by the first user directed at the least second user via an audio or video communication channel, the instruction specifying the type of feedback requested of the at least second user;
transmitting a feedback input from the at least second electronic device to the first electronic device; and
displaying the transmitted feedback input on the display of the first electronic device.
